(19) United States
(12) Patent Application Publication
(10) Pub. No.: US 2026/0115742 A1
(43) Pub. Date: Apr. 30, 2026

(54) SUBSTRATE COATING APPARATUS

(71) Applicant: Samsung Display Co., Ltd., Yongin-si (KR)

(72) Inventors: TAEHUN JU, Yongin-si (KR); BYUNGSU KIM, Yongin-si (KR); SEUNGMIN HONG, Yongin-si (KR)

(21) Appl. No.: 19/175,423

(22) Filed: Apr. 10, 2025

(30) Foreign Application Priority Data
Oct. 28, 2024 (KR) 10-2024-0148322

(51) Int. Cl. B05B 3/02; B05B 1/30

(52) U.S. Cl. CPC B05B 3/02; B05B 1/30

(57) ABSTRACT

A substrate coating apparatus includes a stage for supporting a substrate, a spray unit configured to eject ink in a first direction toward the substrate, a driving unit connected to the spray unit on the stage and for rotating around a rotational center axis thereof, a detection unit spaced apart from the spray unit, connected to the driving unit, and for photographing the spray unit in a second direction different from the first direction, and a control unit configured to derive a spacing distance between the spray unit and the substrate by using an image of the spray unit, obtained from the detection unit, and information regarding the second direction.

This application claims priority to Korean Patent Application No. 10-2024-0148322, filed on Oct. 28, 2024, and all the benefits accruing therefrom under 35 U.S.C. § 119, the content of which in its entirety is herein incorporated by reference.

### BACKGROUND

### 1. Field

Embodiments of the present disclosure relate to a substrate coating apparatus.

### 2. Description of the Related Art

Electronic devices based on mobility are being widely used. As mobile electronic devices, tablet personal computers (PCs) as well as small electronic devices such as mobile phones have been widely used in recent times.

To support various functions, such mobile electronic devices include a display device for providing a user with visual information, such as images or videos. Recently, as other components for driving display devices have been miniaturized, the proportion of display devices in electronic devices has been gradually increasing, and structures bendable to a certain angle from a flat state have been developed.

A display device may display an image by applying voltage to a specific molecular arrangement of liquid crystals to change the molecular arrangement, and converting changes in optical properties, such as birefringence, optical rotation, dichroism, light scattering characteristics, etc., of liquid crystal cells that emit light due to the change in the molecular arrangement into visual changes.

A liquid crystal display (LCD) device provided in such a display device includes a backlight including a display panel and a light guide plate, and a process of applying ink to the edge of a substrate such as the display panel is performed to prevent light from leaking to the side of the display panel.

In the process of applying ink to the edge of the substrate, it is important to precisely measure an interval between a nozzle tip for applying the ink and the substrate to precisely control a region where the ink is applied and the amount of ink applied.

The above-mentioned background technology is technical information that the inventor possessed for deriving the present disclosure or acquired in the process of deriving the present disclosure, and may not be necessarily said to be known art disclosed to the general public before filing the application of the present disclosure.

### SUMMARY

Embodiments of the present disclosure provide a substrate coating apparatus capable of precisely measuring a distance between a nozzle and a substrate in a process of applying ink to the substrate.

The problem that the present disclosure aims to solve is not limited to the problems mentioned above, and other problems and advantages of the present disclosure that are not mentioned can be understood through the following description and may be understood more clearly by the examples of the present disclosure. In addition, it will be appreciated that the problems and advantages to be solved by the present disclosure may be realized by means and combinations thereof indicated in the claims.

According to an embodiment of the present disclosure, a substrate coating apparatus includes a stage for supporting a substrate, a spray unit configured to eject ink in a first direction toward the substrate, a driving unit connected to the spray unit on the stage and for rotating around a rotational center axis thereof, a detection unit spaced apart from the spray unit, connected to the driving unit, and for photographing the spray unit in a second direction different from the first direction, and a control unit configured to derive a spacing distance between the spray unit and the substrate by using an image of the spray unit, obtained from the detection unit, and information regarding the second direction.

In an embodiment, the detection unit may include an imaging module configured to obtain the image of the spray unit and a tilting unit connected to the imaging module and the driving unit and capable of adjusting an angle formed between the imaging module and the substrate.

In an embodiment, the tilting unit may be rotatably connected to the driving unit.

In an embodiment, the spray unit and the detection unit may be further configured to rotate integrally around the rotational center axis of the driving unit.

In an embodiment, the first direction may include a component of a radius direction from the rotational center axis of the driving unit in a plan view.

In an embodiment, the second direction may be a longitudinal direction of a imaging module of the detection unit and form a preset angle with the first direction.

In an embodiment, the preset angle formed between the first direction and the second direction may be less than or equal to 25 degrees.

In an embodiment, the substrate coating apparatus may further include a housing accommodating the driving unit and the stage therein.

In an embodiment, the detection unit may rotate and/or move in an inner area of the housing, and the detection unit and an inner circumferential surface of the housing may be spaced apart from each other by a preset interval.

In an embodiment, an angle formed between a longitudinal center axis of the spray unit and the substrate may be greater than an angle formed between a longitudinal center axis of the detection unit and the substrate.

In an embodiment, the control unit may be further configured to derive a spacing distance between the spray unit and the substrate by using an angle formed between a plane parallel to the substrate and the second direction.

In an embodiment, the control unit may be further configured to control driving of the tilting unit such that a photographing direction of the imaging module and the substrate are parallel to each other at a preset point in time.

In an embodiment, a position of the spray unit may be fixed at the preset point in time.

In an embodiment, the control unit may be further configured to limit rotation and/or movement of the driving unit during an operation of the tilting unit.

In an embodiment, the rotational center axis of the driving unit and a rotational axis of the tilting unit may be perpendicular to each other.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure described later, so the present disclosure should not be construed as being limited to the matters shown in such drawings in which:

FIG. 1 is a perspective view of a substrate coating apparatus according to an embodiment of the present disclosure;

FIG. 2 is a side view of the substrate coating apparatus shown in FIG. 1;

FIG. 3 is a use state diagram showing a state of the substrate coating apparatus of FIG. 1 applying ink to a substrate;

FIG. 4 is a plan view of the substrate coating apparatus shown in FIG. 3;

FIG. 5 is a view for describing a method of deriving a spacing distance between a spray unit and a substrate by using a photographing direction of a detection unit;

FIG. 6 is a use state diagram showing a use state of a controller according to an embodiment of the present disclosure;

FIG. 7 is a plan view schematically showing a display device to which ink is applied by a substrate coating apparatus according to embodiments of the present disclosure; and

FIG. 8 is a cross-sectional view showing a sub-pixel of the display device of FIG. 7.

### DETAILED DESCRIPTION

The present disclosure may have various modifications thereto and various embodiments, and thus particular embodiments will be illustrated in the drawings and described in detail in a detailed description. Effects and features of the present disclosure, and methods for achieving them will become clear with reference to the embodiments described later in detail together with the drawings. However, the present disclosure is not limited to the embodiments disclosed below and may be implemented in various forms.

In the following embodiments, the terms such as “first”, “second”, etc., have been used to distinguish one component from other components, rather than limiting.

In the following embodiments, singular forms include plural forms unless apparently indicated otherwise contextually.

In the following embodiments, the terms “include”, “have”, or the like, are intended to mean that there are features, or components, described herein, but do not preclude the possibility of adding one or more other features or components.

In the following embodiments, when a portion, such as a film, a region, a component, etc., is present on or above another portion, this case may include not only a case where it is directly on the other portion, but also a case where another film, region, component, etc., is arranged between the portion and the other portion.

In the examples below, terms such as connect or combine do not necessarily imply a direct and/or fixed connection or combination of two members, unless the context clearly indicates otherwise, and do not exclude the presence of another member between the two members.

In the drawings, the size of components may be exaggerated or reduced for convenience of description. In some embodiments, since the size and thickness of each component shown in the drawings are arbitrarily shown for convenience of description, the disclosure is not necessarily limited to the illustrated bar.

Hereinafter, embodiments of the present disclosure will be described in detail with reference to the accompanying drawings, and in description with reference to the drawings, the same or corresponding components are given the same reference numerals, and redundant description thereto will be omitted.

A substrate coating apparatus 1 according to an embodiment of the present disclosure may be an apparatus for applying ink to a substrate DS such as a display panel.

For example, the substrate coating apparatus 1 may be used in an inkjet printing process, a screen printing process, a slot die coating process, etc., during a process of manufacturing the substrate DS.

In particular, the substrate coating apparatus 1 may be used in an edge light blocking (ELB) process performed to prevent light leakage, and specifically, in the ELB process, the substrate coating apparatus 1 may apply ink to an edge of the substrate DS while moving along the edge of the substrate DS.

Thus, light leakage that may occur on the display panel may be effectively reduced, thereby greatly improving the visual quality and image consistency of the display.

Specifically, the substrate DS such as the display panel, etc., processed through the ELB process may provide a clear and uniform screen without interference from ambient light, thereby effectively outputting high-resolution images.

As an interval between a nozzle 310 of the spray unit 300 and the substrate DS needs to be precisely set or maintained during the process of applying ink in the substrate coating apparatus 1, the interval between the nozzle 310 and the substrate DS has to be precisely measured.

The substrate coating apparatus 1 according to an embodiment of the present disclosure may include a detection unit 400 that measures an interval between the spray unit 300 and the substrate DS while rotating integrally with the spray unit 300 to precisely measure the interval between the spray unit 300 and the substrate DS regardless of a position of the spray unit 300, as will be described in detail in this regard.

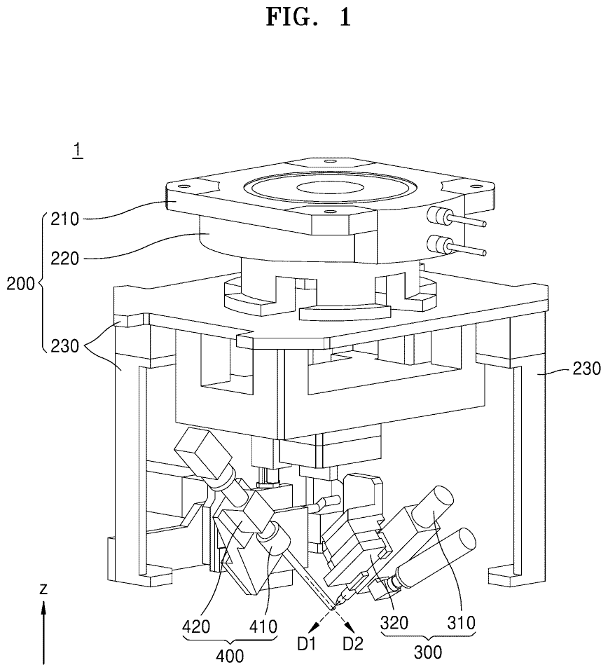

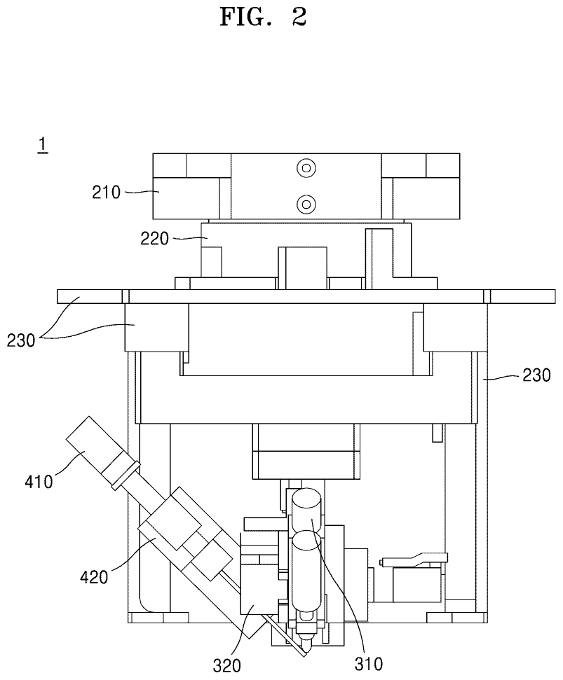

FIG. 1 is a perspective view of the substrate coating apparatus 1 according to an embodiment of the present disclosure. FIG. 2 is a side view of the substrate coating apparatus 1 shown in FIG. 1.

Referring to FIGS. 1 and 2, the substrate coating apparatus 1 according to an embodiment of the present disclosure may include a stage 100, a driving unit 200, the spray unit 300, the detection unit 400, and a control unit 500.

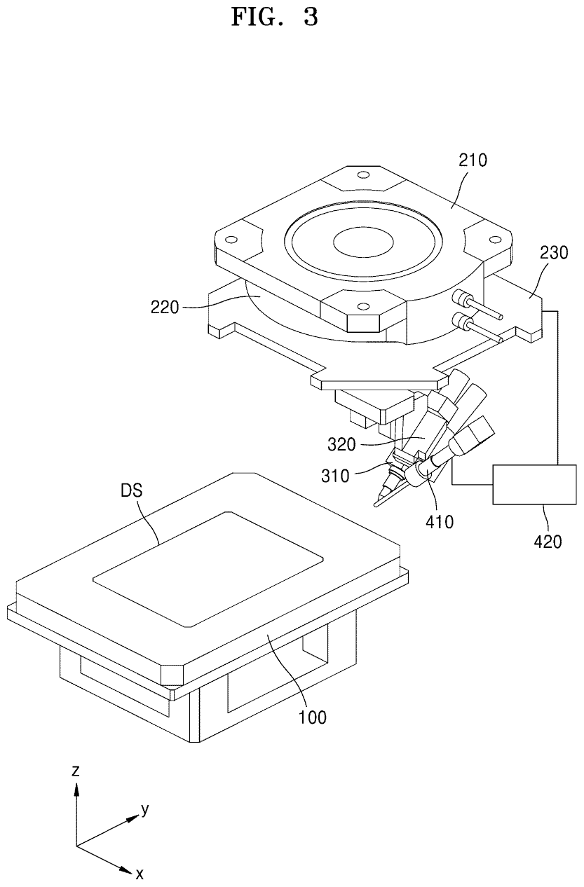

The stage 100 is where the nozzle 310 from which ink is sprayed is mounted, and a description of the stage 100 will be given in the description of FIG. 3 provided below.

The driving unit 200 may control the position of the spray unit 300 and may include a linear motion unit 210, a rotational motion unit 220, and a connecting frame 230.

The detection unit 400 may be connected to a side of the driving unit 200, and the detection unit 400 may be connected to the other side of the driving unit 200 that is different from a side to which the spray unit 300 is connected.

For example, the spray unit 300 may be connected to a side of a rotational center axis of the driving unit 200 (specifically, the rotational motion unit 220), and the detection unit 400 may be connected to a side of the driving unit 200 that is located further from the rotational center axis of the driving unit 200 than the spray unit 300.

The spray unit 300 and the detection unit 400 are each connected to the driving unit 200 such that the spray unit 300 and the detection unit 400 may move integrally or rotate around the same rotational center axis (e.g., z-axis) of the driving unit 200 by the movement and rotation of the driving unit 200.

The linear motion unit 210 may receive power from an external source and move linearly along a preset path, and as the linear motion unit 210 moves linearly, the spray unit 300 and the detection unit 400 may move along a side portion of the substrate DS. The side portion of the substrate DS may include a longitudinal side parallel to y-axis direction and a latitudinal side parallel to x-axis direction (See FIGS. 3, 4 and 7).

The linear motion unit 210 may be a rail system including a rail (not shown in the drawing) placed on the stage 100 and a roller or a gear moving along the rail.

However, the present disclosure is not limited thereto, and the linear motion unit 210 may include various devices within the technical concept, which may move along a preset path by receiving power from an external source, such as a linear actuator, an XY stage, a robot arm, a belt pulley system, a piezoelectric actuator, an electric slider, a gantry system, a cable driving device, etc.

The rotational motion unit 220 may receive power from an external source and rotate around a preset rotational center axis (i.e., the rotational center axis of the driving unit 200), and as the rotational motion unit 220 rotates, the spray unit 300 and the detection unit 400 may rotate integrally around the rotational center axis of the rotational motion unit 220 on the substrate DS.

The rotational motion unit 220 may be connected to a bottom of the linear motion unit 210. For example, the rotational motion unit 220 may be connected to a side of the linear motion unit 210 facing the stage 100.

The rotational motion unit 220 may be placed between the linear motion unit 210 and the spray unit 300, and specifically, the rotational motion unit 220 may be placed between the linear motion unit 210 and the connecting frame 230 to which the spray unit 300 and the detection unit 400 are connected, and thus may be connected to the connecting frame 230 and the linear motion unit 210.

Thus, as the linear motion unit 210 moves along the preset path, the rotational motion unit 220 connected to the linear motion unit 210 may move integrally with the linear motion unit 210, and the spray unit 300 and the detection unit 400 connected to the rotational motion unit 220 via the connecting frame 230 may also move integrally with the linear motion unit 210.

In this way, the spray unit 300 may spray ink to the side portion of the substrate DS while moving along an outer or side circumference of the substrate DS, and the detection unit 400 may be connected to the connecting frame 230 like the spray unit 300 to move integrally with the spray unit 300, thereby detecting a distance between the spray unit 300 and the substrate DS regardless of the position of the spray unit 300.

In addition, as the rotational motion unit 220 moves along a preset path, the spray unit 300 and the detection unit 400 connected to the rotational motion unit 220 via the connecting frame 230 may also rotate around the same axis as the rotational motion unit 220.

Thus, when the spray unit 300 is positioned at the edge of the side circumference of the substrate DS, the rotational motion unit 220 may rotate by a preset angle such that the spray unit 300 may spray ink to the side portion of the substrate DS while moving along the four edges of the substrate DS.

The rotational motion unit 220 may include various devices capable of providing a rotational force by receiving power from an external source.

For example, the rotational motion unit 220 may include a rotary actuator, a servo motor, a stepper motor, a turntable, a universal joint, a cam driving system, a rotor, etc.

The connecting frame 230 may be positioned under the rotational motion unit 220. The connecting frame 230 may connect the rotational motion unit 220 to the spray unit 300 while simultaneously connecting the rotational motion unit 220 to the detection unit 400.

The connecting frame 230 may be fixedly positioned on the rotational motion unit 220 and may move and/or rotate integrally with the rotational motion unit 220.

The spray unit 300 may be rotatably connected to the connecting frame 230, and for example, the nozzle 310 may be rotatably connected to the connecting frame 230 via a first tilting unit 320 on a side of the connecting frame 230.

The detection unit 400 may be rotatably connected to the connecting frame 230, and for example, an imaging module 410 may be rotatably connected to the connecting frame 230 via a second tilting unit 420 on a side of the connecting frame 230.

A region of the connecting frame 230 to which the detection unit 400 is connected may be positioned further from the rotational center axis of the driving unit 200 than another region of the connecting frame 230 to which the spray unit 300 is connected.

Thus, the spray unit 300 and the detection unit 400 may be simultaneously connected to the connecting frame 230, but the spray unit 300 and the detection unit 400 may be spaced apart from each other in a radius direction from the rotational center axis of the driving unit 200 in a plan view, thereby reducing a phenomenon in which a tilting motion of the spray unit 300 and a tilting motion of the detection unit 400 interfere with or overlap each other.

The connecting frame 230 may include various devices capable of fixing the detection unit 400 and the spray unit 300 with respect to the rotational motion unit 220, and for example, the connecting frame 230 may include a bracket, a frame, a clamp, a pivot device, a magnetic fixing device, a jig, etc.

The spray unit 300 according to an embodiment of the present disclosure may eject ink toward the substrate DS and may be fixedly positioned to a side of the connecting frame 230.

The spray unit 300 may include the nozzle 310 that sprays ink to be applied to the side of the substrate DS. The spray unit 300 may move along the circumference of the side portion of the substrate DS, and the nozzle 310 may apply ink to the side portion to form a light-blocking coating layer on the side portion.

The nozzle 310 may spray the ink onto the side of the substrate DS, and the ink may be pigment-type ink containing a light-blocking agent for preventing light leakage of the substrate DS.

For example, the ink may contain resins, pigments, and other ingredients to provide a light-blocking function and isopropyl alcohol (IPA) resistance. As the ink may be applied in a spray manner, it may contain a quick-drying solvent. That is, the ink may contain a suitable solvent such that the ink containing the solvent dries within about 5 seconds after being sprayed.

An angle formed between the longitudinal center axis of the spray unit 300 (specifically, the nozzle 310) and the substrate DS may be greater than an angle formed between the longitudinal center axis of the detection unit 400 (specifically, the imaging module 410) and the substrate DS.

The angle formed between a direction in which the nozzle 310 sprays the ink and a surface of the substrate DS other than the side may be greater than an angle formed between the photographing direction of the imaging module 410 and the surface of the substrate DS.

Accordingly, by detecting a vertical spacing distance between the nozzle 310 and the substrate DS while the imaging module 410 being tilted more gently than the nozzle 310, the vertical spacing distance between the nozzle 310 and the substrate DS may be detected more precisely.

The first tilting unit 320 may connect the nozzle 310 to the connecting frame 230 and may rotate the nozzle 310 with respect to the connecting frame 230.

The rotational axis of the first tilting unit 320 may be perpendicular to the rotational center axis of the rotational motion unit 220.

As the first tilting unit 320 performs a tilting motion, an angle formed between the nozzle 310 and the substrate DS may be adjusted.

As an optional embodiment, the first tilting unit 320 may adjust the interval between the nozzle 310 and the rotational motion unit 220. Thus, the spacing distance between the nozzle 310 and the substrate DS may be adjusted by an operation of the first tilting unit 320.

The first tilting unit 320 may include various devices capable of adjusting the position and/or posture of the nozzle 310 with respect to the connecting frame 230, and for example, the first tilting unit 320 may include a pivot joint, a multi-joint manipulator, a multi-axis link, a gear assembly, etc.

The spray unit 300 may eject ink in a first direction D1 toward the substrate DS, and in the present specification, the ‘first direction’ is defined as a direction in which the ink is ejected.

The first direction D1 may be a direction from an outer side to an inner side in the radius direction from the rotational center axis of the driving unit 200, for example, a direction including a first component (perpendicular to the z-axis direction) from the outer side to the inner side in the radius direction and a second component (z-axis direction) from a top to a bottom of the substrate DS.

The detection unit 400 according to an embodiment of the present disclosure may photograph the spray unit 300 in a second direction D2 different from the first direction D1, and may include the imaging module 410 and the second tilting unit 420.

The detection unit 400 may be connected to the driving unit 200 while being spaced apart from the spray unit 300. For example, the spray unit 300 and the detection unit 400 may be spaced apart in the radius direction from the rotational center axis of the driving unit 200 in a plan view and connected to different regions of the connecting frame 230.

The imaging module 410 may obtain an image of the spray unit 300, for example, an image including a tip of the nozzle 310 and the substrate DS.

The imaging module 410 may provide the obtained image to the control unit 500, and the control unit 500 may derive a spacing distance between the tip of the nozzle 310 and the substrate DS using an image provided from the imaging module 410.

The imaging module 410 may include a vision camera or a laser distance sensor capable of obtaining information about the spacing distance between the tip of the nozzle 310 and the substrate DS.

However, the present disclosure is not limited thereto, and the imaging module 410 may include various devices capable of detecting the spacing distance between the tip of the nozzle 310 and the substrate DS, such as an ultrasonic distance sensor, an optical distance sensor, a capacitive sensor, an inductive sensor, an air gap sensor, a confocal sensor, a touch probe, etc.

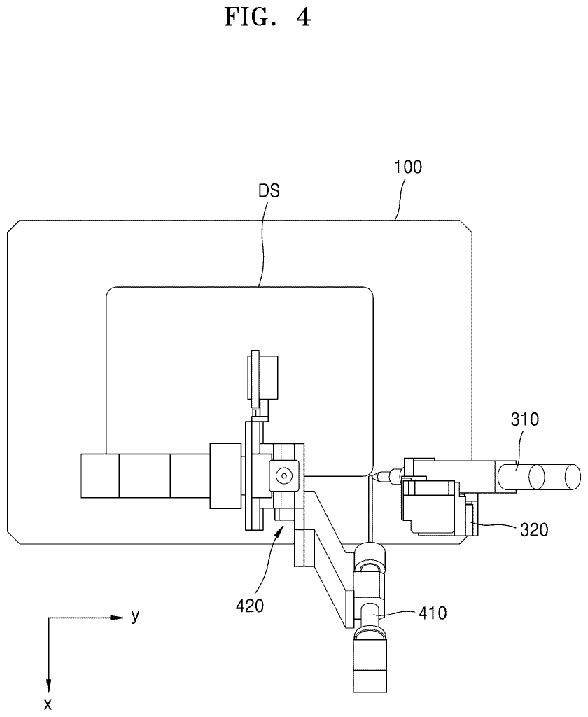

FIG. 3 is a use state diagram showing a state of the substrate coating apparatus 1 of FIG. 1 applying ink to the substrate DS, and FIG. 4 is a plan view of the substrate coating apparatus 1 shown in FIG. 3. As used herein, the plan view is a view in a rotational center direction (i.e., z-axis direction) of the driving unit 200 or view in a thickness direction of the substrate DS.

Referring to FIGS. 3 and 4, the substrate coating apparatus 1 may apply ink to the side portion of the substrate DS while moving along the side portion of the substrate DS placed on the stage 100.

The stage 100 may have a plane having the same shape as the substrate DS. The side portion of the substrate DS placed on the stage 100 may be exposed to the outside, and the spray unit 300 may spray the ink along the side portion of the substrate DS to form a light-blocking coating layer on the side portion.

The stage 100 may be made of metal, for example, aluminum.

The photographing direction of the imaging module 410 to the tip of the nozzle 310 and the substrate DS may be the second direction D2 different from the first direction D1.

The ‘second direction’ may be a longitudinal direction of the imaging module 410 and may form a preset angle with the first direction D1 in which the preset angle may be 25 degrees or less.

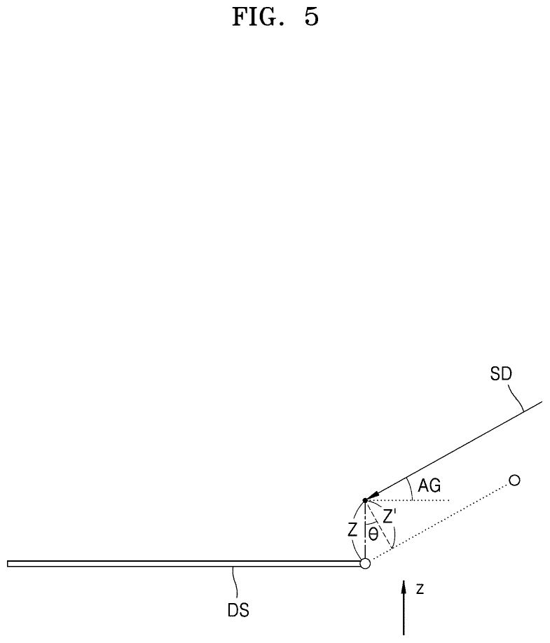

An angle (e.g., AG in FIG. 5) formed between the first direction D1 and a surface of the substrate DS may be equal to or greater than an angle formed between the second direction D2 and the surface of the substrate DS.

A surface of the substrate DS may be a top surface of the substrate DS that is different from the side of the substrate DS to which the ink is applied, and for example, the surface of the substrate DS may be interpreted as the surface of the substrate DS that faces the rotational motion unit 220.

The second tilting unit 420 may connect the imaging module 410 to the connecting frame 230, and the second tilting unit 420 may be connected to the imaging module 410 and the driving unit 200 and may adjust the angle formed between the imaging module 410 and the substrate DS.

Specifically, the second tilting unit 420 may include a driving motor, and the second tilting unit 420 may rotate the imaging module 410 around a preset axis using the rotational force provided by the driving motor.

For example, the second tilting unit 420 may adjust the second direction D2, which is the photographing direction of the imaging module 410, by rotating around the preset axis.

The second tilting unit 420 may be rotatably connected to the driving unit 200, and the imaging module 410 may rotate around the preset axis with respect to the connecting frame 230, for example, by the tilting motion of the second tilting unit 420.

This allows the imaging module 410 to obtain an image including the tip of the nozzle 310 from different angles several times by the tilting motion of the second tilting unit 420.

In this way, the control unit 500 may calculate the spacing distance between the tip of the nozzle 310 and the substrate DS several times from a plurality of images obtained at different angles, thereby enabling the control unit 500 to precisely detect the vertical distance between the tip of the nozzle 310 and the substrate DS.

The rotational axis of the second tilting unit 420 or the rotational axis of the imaging module 410 may be perpendicular to the rotational center axis of the driving unit 200.

The rotational axis of the second tilting unit 420 and the rotational axis of the first tilting unit 320 may form a preset angle therebetween, and the preset angle may be 65 degrees or greater.

During rotation and/or movement of the driving unit 200, the tilting motion of the second tilting unit 420 may be limited.

For example, the control unit 500 may limit a motion of the second tilting unit 420 such that the angle formed between the imaging module 410 and the substrate DS is fixed during the rotation and/or movement of the driving unit 200.

The second tilting unit 420 may limit the angle formed between the imaging module 410 and the substrate DS to a preset range, and the second tilting unit 420 may limit the angle formed between the imaging module 410 and the substrate DS to at least 0 degree but not more than 45 degrees.

For example, the second tilting unit 420 may limit the angle formed between the second direction D2 and the substrate DS to at least 0 degree but not more than 45 degrees.

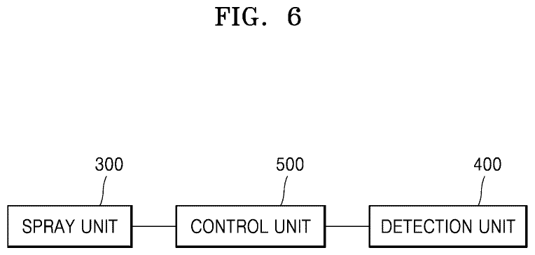

FIG. 5 is a view for describing a method of deriving (i.e., calculating) the spacing distance between the spray unit 300 and the substrate DS by using the photographing direction of the detection unit 400, and FIG. 6 is a use state diagram showing a use state of a controller according to an embodiment of the present disclosure.

The control unit 500 according to an embodiment of the present disclosure may derive the spacing distance between the spray unit 300 and the substrate DS, and the control unit 500 may derive the spacing distance between the spray unit 300 and the substrate DS by using the image of the spray unit 300 obtained from the detection unit 400 and information about the second direction D2.

For example, the control unit 500 may derive the vertical distance between the tip of the nozzle 310 and the substrate DS by using an image including the tip of the nozzle 310 and the substrate DS, in which case the control unit 500 may derive the vertical distance between the tip of the nozzle 310 and the substrate DS using triangulation using the second direction D2.

The control unit 500 may perform primary measurement and secondary measurement on the spacing distance between the tip of the nozzle 310 and the substrate DS, and hereinafter, a method for the control unit 500 to perform primary measurement and secondary measurement on the spacing distance between the tip of the nozzle 310 and the substrate DS will be described.

In the primary measurement of the spacing distance between the tip of the nozzle 310 and the substrate DS, the control unit 500 may control driving of the second tilting unit 420 to adjust the angle between a photographing direction SD of the imaging module 410 and the substrate DS to a first measured angle AG.

The control unit 500 may control driving of the second tilting unit 420 such that the first measured angle AG is greater than 0 degree and less than 50 degrees, and for example, the control unit 500 may control driving of the second tilting unit 420 such that the first measured angle AG is at least 25 degrees but not more than 45 degrees.

In the primary measurement, the detection unit 400 may be positioned obliquely such that its longitudinal center axis of the detection unit 400 forms the first measured angle AG with respect to the substrate DS, and thus the rotational radius of the detection unit 400 may be reduced compared to when the detection unit 400 is positioned parallel to the substrate DS, thereby improving the space utilization of the substrate coating apparatus 1.

However, as the detection unit 400 photographs the tip of the nozzle 310 and the substrate DS in an oblique direction during the primary measurement, a spacing distance Z′ between the tip of the nozzle 310 and the substrate DS included in the image obtained from the detection unit 400 (hereinafter referred to as a ‘measured distance’) may be measured as being less than an actual spacing distance Z between the tip of the nozzle 310 and the substrate DS (hereinafter referred to as an ‘actual distance’), which is measured in the z-axis direction.

The control unit 500 may calculate the actual distance Z based on the measured distance Z′ by the detection unit 400 using the photographing direction SD of the tip of the nozzle 310 or information about the first measured angle AG during the primary measurement.

For example, the control unit 500 may precisely calculate the actual distance Z from the measured distance Z′ by using a triangular relationship between the measured distance Z′ between the tip of the nozzle 310 and the substrate DS and the actual distance Z between the nozzle 310 and the substrate DS based on triangulation.

During the primary measurement, the control unit 500 may calculate the actual distance Z using Equation 1 provided below.

$$Actual Distance ( Z ) = \frac{Measured Distance ( {Z}^{′} )}{cos ( First Measured Angle ( AG ) )} \qquad [ Equation 1 ]$$

The primary measurement may be performed simultaneously with the driving of the driving unit 200. For example, while the spray unit 300 moves due to the driving the linear motion unit 210 and the rotational motion unit 220, the control unit 500 may primarily measure the spacing distance between the tip of the nozzle 310 and the substrate DS using the detection unit 400.

After the primary measurement, the control unit 500 may control the driving of the second tilting unit 420 to perform secondary measurement on the spacing distance between the tip of the nozzle 310 and the substrate DS.

In the secondary measurement, the control unit 500 may control the driving of the second tilting unit 420 to adjust a posture of the imaging module 410 such that the photographing direction of the imaging module 410 is parallel or nearly parallel to the substrate DS.

In the secondary measurement, as the longitudinal center axis of the detection unit 400 or the photographing direction of the detection unit 400 is arranged parallel to the substrate DS, the measured distance between the tip of the nozzle 310 and the substrate DS may be the same as or nearly the same as the actual distance between the nozzle 310 and the substrate DS.

In this case, the control unit 500 may detect the actual distance between the tip of the nozzle 310 and the substrate DS directly from the image obtained by the detection unit 400.

The control unit 500 may derive the actual distance between the tip of the nozzle 310 and the substrate DS by using the actual distance between the tip of the nozzle 310 and the substrate DS detected in the secondary measurement and the actual distance Z between the tip of the nozzle 310 and the substrate DS detected in the primary measurement.

In an embodiment, the control unit 500 may calculate the actual distance between the tip of the nozzle 310 and the substrate DS by adding a product of the actual distance Z, calculated from the measured distance Z′ in the primary measurement, and a first weight value and a product of the actual distance, obtained in the secondary measurement, and a second weight value.

The control unit 500 may set the second weight value to be greater than the first weight value.

In an embodiment, the control unit 500 may correct a value such as the first measured angle AG set in the primary measurement using the actual distance obtained in the secondary measurement.

In an embodiment, the control unit 500 may determine that there is an error in the primary measurement, when a difference between the actual distance obtained in the secondary measurement and the actual distance Z calculated in the primary measurement is calculated as being not more than a preset value.

During the secondary measurement of the control unit 500, the control unit 500 may limit the operation of the driving unit 200 to fix the position of the spray unit 300.

For example, while the control unit 500 performs a tilting motion of the second tilting unit 420 for the secondary measurement, the control unit 500 may limit the rotation and/or movement of the driving unit 200.

Accordingly, in a situation where, for the secondary measurement between the tip of the nozzle 310 and the substrate DS, the imaging module 410 is arranged horizontally or nearly horizontally with respect to the substrate DS and thus the rotational radius of the imaging module 410 is excessively large, the driving unit 200 may rotate, thereby reducing collision between an end portion of the imaging module 410 and other structures.

The control unit 500 may control the driving of the spray unit 300 by using the detected spacing distance between the tip of the nozzle 310 and the substrate DS.

For example, the control unit 500 may appropriately adjust the spacing distance between the tip of the nozzle 310 and the substrate DS by controlling the operation of the first tilting unit 320 using the detected spacing distance between the tip of the nozzle 310 and the substrate DS.

Although not shown in the drawing, the substrate coating apparatus 1 according to an embodiment of the present disclosure may further include a housing that accommodates the driving unit 200 and the stage 100 therein.

The driving unit 200 may rotate or move inside the housing, and the spray unit 300 and detection unit 400 may rotate or move inside the housing.

An inner circumferential surface of the detection unit 400 and the housing may be spaced apart at preset intervals such that when the spacing distance between the tip of the nozzle 310 and the substrate DS is primarily or secondarily measured, collision between the detection unit 400 and the housing may be prevented.

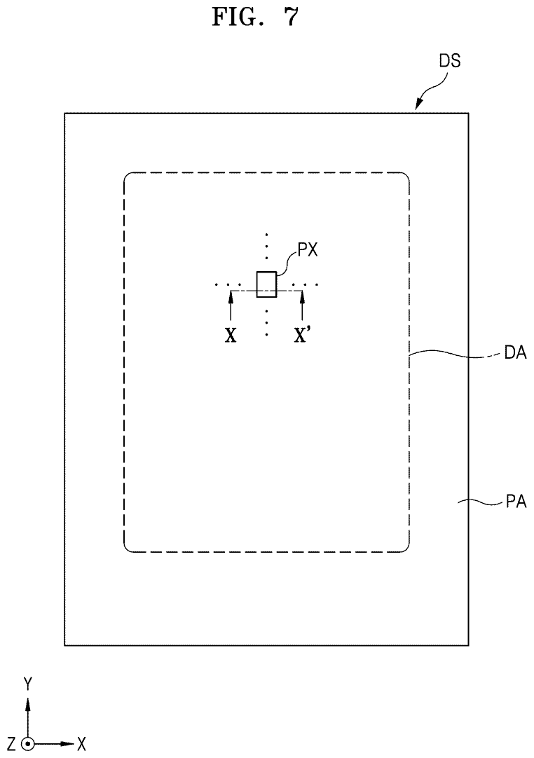

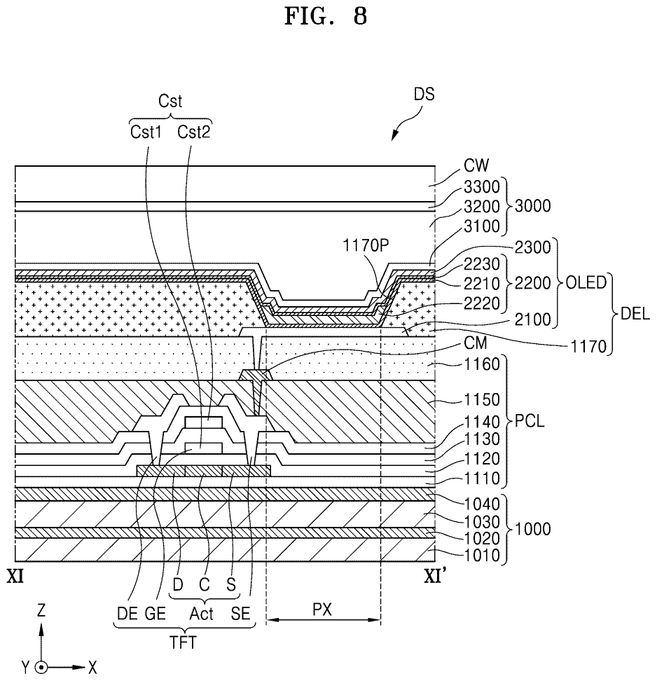

FIG. 7 is a plan view schematically showing a display device manufactured by a manufacturing device of the display device according to embodiments of the present disclosure. FIG. 8 is a cross-sectional view showing a sub-pixel of the display device of FIG. 7.

Referring to FIG. 7, a display device DS manufactured according to an embodiment of the present disclosure may include a display area DA and a peripheral area PA located outside the display area DA. The display device DS may provide an image through an array of a plurality of pixels PX arranged two-dimensionally in the display area DA.

The peripheral area PA may be an area where an image is not provided and may completely or partially surround the display area DA. In the peripheral area PA, a driver for providing electrical signals or power to a pixel circuit corresponding to each of the plurality of pixels PX may be placed. In the peripheral area PA may be arranged a pad that is a region to which an electronic element, a printed circuit board, etc., may be electrically connected.

Hereinafter, the display device DS is described as including an organic light-emitting diode (OLED) as a light-emitting element, but the display device DS according to the present disclosure is not limited thereto.

In another embodiment, the display device DS may be a light-emitting display device including an inorganic light-emitting diode, i.e., an inorganic light-emitting display. The inorganic light-emitting diode may include a PN diode including inorganic semiconductor-based materials.

When voltage is applied in a forward direction to a PN junction diode, holes and electrons may be injected, and energy generated by recoupling between the holes and the electrons may be converted into light energy to emit light of a certain color. The inorganic light-emitting diode may have a width of several to several hundreds of micrometers, and in some embodiments, the inorganic light-emitting diode may be referred to as a micro LED.

In another embodiment, the display device DS may be a quantum dot light-emitting display.

Meanwhile, the display device DS may be used as a display screen for various products such as not only portable electronic devices including a mobile phone, a smart phone, a tablet personal computer (PC), a mobile communication terminal, an electronic notebook, an electronic book, a portable multimedia player (PMP), a navigation device, an ultra-mobile PC (UMPC), etc., but also a television, a laptop, a monitor, a billboard, an Internet of Things (IOT) device, etc.

The display device DS according to an embodiment may be used in a wearable device such as a smart watch, a watch phone, a glasses-type display, and a head mounted display (HMD).

The display device DS according to an embodiment may be used as a dashboard of a vehicle and a center information display (CID) placed on a center fascia or dashboard of a vehicle, a room mirror display replacing a side mirror of a vehicle, or a display screen placed on the back of a front seat as entertainment for a rear seat of a vehicle.

Referring to FIG. 8, the display device DS may include a laminated structure of a substrate 1000, a pixel circuit layer PCL, a display element layer DEL, and an encapsulation layer 3000.

The substrate 1000 may have a multilayer structure including a base layer containing polymer resin and an inorganic layer. For example, the substrate 1000 may include a base layer including polymer resin and a barrier layer of an inorganic insulating layer.

For example, the substrate 1000 may include a first base layer 1010, a first barrier layer 1020, a second base layer 1030, and a second barrier layer 1040 that are sequentially laminated. The first base layer 1010 and the second base layer 1030 may include polyimide (PI), polyethersulfone (PES), polyarylate, polyetherimide (PEI), polyethylene naphthalate (PEN), polyethylene terephthalate (PET), polyphenylene sulfide (PPS), polycarbonate (PC), cellulose triacetate (TAC), or/and cellulose acetate propionate (CAP).

The first barrier layer 1020 and the second barrier layer 1040 may include an inorganic insulating material such as silicon oxide, silicon oxynitride, and/or silicon nitride. The substrate 1000 may have flexible characteristics.

The pixel circuit layer PCL may be arranged on the substrate 1000. FIG. 8 shows that the pixel circuit layer PCL includes a buffer layer 1110, a first gate insulating layer 1120, a second gate insulating layer 1130, an interlayer insulating layer 1140, a first planarization insulating layer 1150, and a second planarization insulating layer 1160 that are arranged below and/or above a thin film transistor TFT and components of the thin film transistor TFT.

The buffer layer 1110 may reduce or block the penetration of foreign substances, moisture, or outside air from the bottom of the substrate 1000 and provide a flat surface on the substrate 1000.

The buffer layer 1110 may include an inorganic insulating material such as silicon oxide, silicon oxynitride, or silicon nitride, and may be formed as a single layer or a multilayer structure including the aforementioned materials.

The thin film transistor TFT on the buffer layer 1110 may include a semiconductor layer Act that may include polysilicon.

Alternatively, the semiconductor layer Act may include amorphous silicon, an oxide semiconductor, an organic semiconductor, etc.

The semiconductor layer Act may include a channel region C and a drain region D and a source region S respectively arranged on opposite sides of the channel region C. A gate electrode GE may overlap the channel region C.

The gate electrode GE may include a low-resistance metal material. The gate electrode GE may include a conductive material including molybdenum (Mo), aluminum (Al), copper (Cu), titanium (Ti), etc., and may be formed as multiple layers or a single layer including the materials.

The first gate insulating layer 1120 between the semiconductor layer Act and the gate electrode GE may include an inorganic insulating material such as silicon oxide (SiO₂), silicon nitride (SiNX), silicon oxynitride (SiON), aluminum oxide (Al₂O₃), titanium oxide (TiO₂), tantalum oxide (Ta₂O₅), hafnium oxide (HfO₂), or zinc oxide (ZnOX). Zinc oxide (ZnOX) may be zinc oxide (ZnO) and/or zinc peroxide (ZnO₂).

The second gate insulating layer 1130 may be provided to cover the gate electrode GE. Like the first gate insulating layer 1120, the second gate insulating layer 1130 may include an inorganic insulating material such as silicon oxide (SiO₂), silicon nitride (SiNX), silicon oxynitride (SiON), aluminum oxide (Al₂O₃), titanium oxide (TiO₂), tantalum oxide (Ta₂O₅), hafnium oxide (HfO₂), or zinc oxide (ZnOX). Zinc oxide (ZnOX) may be zinc oxide (ZnO) and/or zinc peroxide (ZnO₂).

An upper electrode Cst2 of a storage capacitor Cst may be placed on the second gate insulating layer 1130. The upper electrode Cst2 may overlap the gate electrode GE thereunder. At this time, the gate electrode GE and the upper electrode Cst2 overlapping each other with the second gate insulating layer 1130 therebetween may form the storage capacitor Cst. That is, the gate electrode GE may function as a lower electrode Cst1 of the storage capacitor Cst.

In this way, the storage capacitor Cst and the thin film transistor TFT may be formed to overlap each other. In some embodiments, the storage capacitor Cst may be formed not to overlap the thin film transistor TFT.

The upper electrode Cst2 may include aluminum (Al), platinum (Pt), palladium (Pd), silver AG, magnesium (Mg), gold (Au), nickel (Ni), neodymium (Nd), iridium (Ir), chromium (Cr), calcium (Ca), molybdenum (Mo), titanium (Ti), tungsten (W), and/or copper (Cu), and may be a single layer or multiple layers of the aforementioned materials.

The interlayer insulating layer 1140 may cover the upper electrode Cst2. The interlayer insulating layer 1140 may include silicon oxide (SiO₂), silicon nitride (SiNX), silicon oxynitride (SiON), aluminum oxide (Al₂O₃), titanium oxide (TiO₂), tantalum oxide (Ta₂O₅), hafnium oxide (HfO₂), or zinc oxide (ZnOX). Zinc oxide (ZnOX) may be zinc oxide (ZnO) and/or zinc peroxide (ZnO₂). The interlayer insulating layer 1140 may be a single layer or multiple layers including the aforementioned inorganic insulating material.

Each of the drain electrode DE and the source electrode SE may be positioned on the interlayer insulating layer 1140. The drain electrode DE and the source electrode SE may be connected to the drain region D and the source region S, respectively, through contact holes formed in the insulating layers therebelow. The drain electrode DE and source electrode SE may include a material having good conductivity. The drain electrode DE and the source electrode SE may include a conductive material including molybdenum (Mo), aluminum (Al), copper (Cu), titanium (Ti), etc., and may be formed as multiple layers or a single layer including the materials. In an embodiment, the drain electrode DE and the source electrode SE may have a multilayer structure of Ti/Al/Ti.

The first planarization insulating layer 1150 may cover the drain electrode DE and the source electrode SE. The first planarization insulating layer 1150 may include an organic insulator such as a general-purpose polymer like polymethylmethacrylate (PMMA) or polystyrene (PS), a polymer derivative having a phenol-based group, an acrylic polymer, an imide polymer, an aryl ether polymer, an amide polymer, a fluorinated polymer, a p-xylene polymer, a vinyl alcohol polymer, and a blend thereof.

The second planarization insulating layer 1160 may be placed on the first planarization insulating layer 1150. The second planarization insulating layer 1160 may include the same material as the first planarization insulating layer 1150, and may include an organic insulator such as a general-purpose polymer like polymethylmethacrylate (PMMA) or polystyrene (PS), a polymer derivative having a phenol-based group, an acrylic polymer, an imide polymer, an aryl ether polymer, an amide polymer, a fluorinated polymer, a p-xylene polymer, a vinyl alcohol polymer, and a blend thereof.

A display element layer DEL may be arranged on the pixel circuit layer PCL of the above-described structure. The display element layer DEL may include the organic light-emitting diode OLED as a display element (i.e., a light-emitting element), and the organic light-emitting diode OLED may include a laminated structure of a pixel electrode 2100, an intermediate layer 2200, and a common electrode 2300. The organic light-emitting diode OLED may emit, for example, red, green, or blue light, or may emit red, green, blue, or white light. The organic light-emitting diode OLED may emit light through their emitting areas that may be defined as the pixels PX.

The pixel electrode 2100 of the organic light-emitting diode OLED may be electrically connected to the thin film transistor TFT through contact holes formed in the second planarization insulating layer 1160 and the first planarization insulating layer 1150 and a contact metal CM disposed on the first planarization insulating layer 1150.

The pixel electrode 2100 may include a conductive oxide such as indium tin oxide (ITO), indium zinc oxide (IZO), zinc oxide (ZnO), indium oxide (In₂O₃), indium gallium oxide (IGO), or aluminum zinc oxide (AZO). In another embodiment, the pixel electrode 2100 may include a reflective film including silver (Ag), magnesium (Mg), aluminum (Al), platinum (Pt), palladium (Pd), gold (Au), nickel (Ni), neodymium (Nd), iridium (Ir), chromium (Cr), or a compound thereof. In another embodiment, the pixel electrode 2100 may further include a film formed of ITO, IZO, ZnO or In₂O₃ above/below the reflective film.

A pixel-defining film 1170 defining an opening 1170P exposing the central portion of the pixel electrode 2100 may be arranged on the pixel electrode 2100. The pixel-defining film 1170 may include an organic insulating material and/or an inorganic insulating material. The opening 1170P may define an emission area of light emitted from the organic light-emitting diode OLED. For example, the size/width of the opening 1170P may correspond to the size/width of the light-emitting area. Thus, the size and/or width of the pixel PX may depend on the size and/or width of the opening 1170P of the corresponding pixel-defining film 1170.

The intermediate layer 2200 may include a light-emitting layer 2220 formed to correspond to the pixel electrode 2100. The light-emitting layer 2220 may include a polymer or low-molecular organic material that emits light of a predetermined color. Alternatively, the light-emitting layer 2220 may include an inorganic light-emitting material or quantum dots.

In an embodiment, the intermediate layer 2200 may include a first functional layer 2210 and a second functional layer 2230 respectively positioned below and above the light-emitting layer 2220. The first functional layer 2210 may include, for example, a hole transport layer (HTL) or a hole transport layer and a hole injection layer (HIL). The second functional layer 2230 may be a component positioned on the light-emitting layer 2220 and may include an electron transport layer (ETL) and/or an electron injection layer (EIL). The first functional layer 2210 and/or the second functional layer 2230 may be a common layer formed to cover the entire substrate 1000, similar to the common electrode 2300 described below.

The common electrode 2300 may be placed on the pixel electrode 2100 and may overlap the pixel electrode 2100. The common electrode 2300 may include a conductive material with a low work function. For example, the common electrode 2300 may include a (semi) transparent layer including silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca), or an alloy thereof. Alternatively, the common electrode 2300 may further include a layer such as ITO, IZO, ZnO or In₂O₃ on the (semi) transparent layer including the aforementioned material. The common electrode 2300 may be formed integrally to cover the entire substrate 1000.

The encapsulation layer 3000 may be placed on the display element layer DEL to cover the display element layer DEL. The encapsulation layer 3000 may include at least one inorganic encapsulation layer and at least one organic encapsulation layer, and in an embodiment, FIG. 8 shows that the encapsulation layer 3000 includes a first inorganic encapsulation layer 3100, an organic encapsulation layer 3200, and a second inorganic encapsulation layer 3300 that are sequentially laminated.

The first inorganic encapsulation layer 3100 and the second inorganic encapsulation layer 3300 may include one or more inorganic materials among aluminum oxide, titanium oxide, tantalum oxide, hafnium oxide, zinc oxide, silicon oxide, silicon nitride, and silicon oxynitride. The organic encapsulation layer 3200 may include a polymer-based material. The polymer-based material may include an acrylic resin, an epoxy resin, polyimide, polyethylene, etc. In an embodiment, the organic encapsulation layer 3200 may include acrylate. The organic encapsulation layer 3200 may be formed by curing a monomer or applying a polymer. The organic encapsulation layer 3200 may have transparency.

Although not shown, a touch sensor layer may be arranged on the encapsulation layer 3000, and an optical function layer may be arranged on the touch sensor layer. The touch sensor layer may obtain coordinate information based on an external input, e.g., a touch event. The optical functional layer may reduce the reflectivity of light (external light) incident from the outside toward the display device and/or improve the color purity of light emitted from the display device. In an embodiment, the optical functional layer may include a phase retarder and/or a polarizer. The phase retarder may be of a film type or liquid crystal coating type, and may include a λ/2 phase retarder and/or a λ/4 phase retarder. The polarizer be a film type or liquid crystal coating type. The film type may include a stretchable synthetic resin film, and the liquid crystal coating type may include liquid crystals arranged in a predetermined array. The phase retarder and the polarizer may further include a protective film.

An adhesive member may be placed between the touch sensor layer and the optical function layer. The adhesive member may be any one known in the art without limitation. The adhesive member may be a pressure sensitive adhesive (PSA).

A cover window CW may be placed on the encapsulation layer 3000, and when the touch sensor layer and/or the optical function layer are placed, the cover window CW may be placed on top thereof. The cover window CW may include at least one of glass, sapphire, and plastic. The cover window CW may be, for example, ultra-thin glass or colorless polyimide. In an embodiment, the cover window CW may have a structure in which a flexible polymer layer is arranged on one surface of a glass substrate, or may include a polymer layer.

The cover window CW may be attached by an adhesive member (not shown). The adhesive member may be a liquid optically clear resin (OCR) or an optically clear adhesive film (OCA) and/or a pressure sensitive adhesive (PSA).

The substrate coating apparatus according to embodiments of the present disclosure may include the detection unit that derives a spacing distance between the spray unit and the substrate by using information about the image of the spray unit and the photographing direction of the detection unit, thereby precisely deriving the spacing distance between the spray unit and the substrate regardless of the photographing direction of the detection unit.

However, effects that may be obtained through the present disclosure are not limited to the-described effects, and other technical effects not mentioned may be clearly understood by those of ordinary skill in the art from the description of the present disclosure described below.

Each of the embodiments described above may be implemented independently, but it goes without saying that the structure of each embodiment may be applied in combination to other embodiments.

Although the present disclosure has been described with reference to an example shown in the drawings, it will be understood by those of ordinary skill in the art that various modifications and equivalent other examples may be made from the shown example. Accordingly, the true technical scope of the present disclosure should be defined by the technical spirit of the appended claims.

Specific implementations described in the embodiments are examples and do not limit the scope of the embodiments in any way. In addition, when there is no specific mentioning, such as “essential” or “important”, it may not be a necessary component for the application of the present disclosure.

In the specification (especially, claims) of the present disclosure, the use of the term “the” and similar indicators thereof may correspond to both the singular and the plural.

Moreover, when a range is described in an example, the present disclosure includes the application of individual values within the range (unless there is a statement to the contrary), and is the same as describing each individual value constituting the range in the detailed description.

Finally, when there is no apparent description of the order of operations constituting the method according to the disclosure or a contrary description thereof, the operations may be performed in an appropriate order. However, the embodiments are not necessarily limited according to the describing order of the operations.

The use of all examples or exemplary terms in the present disclosure are to simply describe the disclosure in detail, and unless the range of the disclosure is not limited by the examples or the exemplary terms unless limited by the claims.

In addition, it may be understood by those of ordinary skill in the art that various modifications, combinations, and changes may be made according to design conditions and factors within the scope of the appended claims or equivalents thereof.

What is claimed is:

1. A substrate coating apparatus comprising:
a stage, which supports a substrate;
a spray unit configured to eject ink in a first direction toward the substrate;
a driving unit connected to the spray unit on the stage and configured to rotate around a rotational center axis thereof;
a detection unit spaced apart from the spray unit, connected to the driving unit, and configured to photograph the spray unit in a second direction different from the first direction; and
a control unit configured to derive a spacing distance between the spray unit and the substrate by using an image of the spray unit obtained from the detection unit, and information regarding the second direction.

2. The substrate coating apparatus of claim 1, wherein the detection unit comprises:
an imaging module configured to obtain the image of the spray unit; and
a tilting unit connected to the imaging module and the driving unit and configured to adjust an angle formed between the imaging module and the substrate.

3. The substrate coating apparatus of claim 2, wherein the tilting unit is rotatably connected to the driving unit.

4. The substrate coating apparatus of claim 1, wherein the spray unit and the detection unit are further configured to rotate integrally around the rotational center axis of the driving unit.

5. The substrate coating apparatus of claim 1, wherein the first direction comprises a component of a radius direction from the rotational center axis of the driving unit in a plan view.

6. The substrate coating apparatus of claim 5, wherein the second direction is a longitudinal direction of a imaging module of the detection unit and forms a preset angle with the first direction.

7. The substrate coating apparatus of claim 6, wherein the preset angle formed between the first direction and the second direction is less than or equal to 25 degrees.

8. The substrate coating apparatus of claim 1, further comprising a housing accommodating the driving unit and the stage therein.

9. The substrate coating apparatus of claim 8, wherein the detection unit rotates and/or moves in an inner area of the housing, and the detection unit and an inner circumferential surface of the housing are spaced apart from each other by a preset interval.

10. The substrate coating apparatus of claim 1, wherein an angle formed between a longitudinal center axis of the spray unit and the substrate is greater than an angle formed between a longitudinal center axis of the detection unit and the substrate.

11. The substrate coating apparatus of claim 1, wherein the control unit is further configured to derive a spacing distance between the spray unit and the substrate by using an angle formed between a plane parallel to the substrate and the second direction.

12. The substrate coating apparatus of claim 2, wherein the control unit is further configured to control driving of the tilting unit such that a photographing direction of the imaging module and the substrate are parallel to each other at a preset point in time.

13. The substrate coating apparatus of claim 12, wherein a position of the spray unit is fixed at the preset point in time.

14. The substrate coating apparatus of claim 2, wherein the control unit is further configured to limit rotation and/or movement of the driving unit during an operation of the tilting unit.

15. The substrate coating apparatus of claim 2, wherein the rotational center axis of the driving unit and a rotational axis of the tilting unit are perpendicular to each other.
